(19) United States
(12) Patent Application Publication
(10) Pub. No.: US 2024/0220890 A1
(43) Pub. Date: Jul. 4, 2024

(54) CENTRALIZED BUDGET APPROVAL SYSTEM AND METHOD

(71) Applicant: Rakuten Symphony Singapore Pte. Ltd., Singapore (SG)

(72) Inventors: Anindita DATTA, Tokyo (JP); Hitomi WAKI, Tokyo (JP)

(21) Appl. No.: 17/756,479

(22) PCT Filed: Apr. 1, 2022
(86) PCT No.: PCT/US2022/022980

§ 371 Date: Oct. 5, 2023

(51) Int. Cl. G06Q 10/0631

(52) U.S. Cl. CPC G06Q 10/06315; G06Q 10/06313

(57) ABSTRACT

A method executed by processing circuitry includes causing a first graphical user interface (GUI) to be output by a first user interface (UI) includes a first user input field configured to receive a first user input identifying a person-in-charge (PIC) to log in to a centralized budget approval system (CBAS); in response to a successful log into the CBAS, obtaining master data from a non-transitory computer readable medium, the master data being associated with the PIC; determining, based on the master data, a region associated with the PIC; receiving a request from the PIC to create a departmental budget application associated with the determined region; determining a department budget associated with the departmental budget application; and obtaining information of each departmental budget application associated with the department.

### BACKGROUND

A budget is a financial plan for a defined period. A budget further includes planned sales volumes and revenues, resource quantities, costs and expenses, assets, liabilities, and cash flows. Companies, governments, families, and other organizations use a budget to express strategic plans of activities or events in measurable terms. A budget is the summation of finances allocated for a particular purpose and the summary of intended expenditures along with proposals for how to meet the intended expenditures. A budget includes a budget surplus, providing money for use at a future time, a deficit in which expenses exceed income, or a balanced budget where the expenses are equal to the income.

Often, an organization, such as companies, governments, and other organizations, include multiple departments, each of which includes multiple project-teams working on separate projects. Typically, a person-in-charge (PIC) of a given department is responsible for managing the workflow of the department, and the PIC of a given project is responsible for managing the workflow of the project.

### BRIEF DESCRIPTION OF THE DRAWINGS

Aspects of the present disclosure are best understood from the following detailed description when read with the accompanying figures. In accordance with the standard practice in the industry, various features are not drawn to scale. The dimensions of the various features are arbitrarily increased or reduced for clarity of discussion.

FIG. 1 is a block diagram of centralized budget approval system (CBAS), in accordance with some embodiments.

FIG. 2 is a flowchart of a method for budget approval, in accordance with some embodiments.

FIG. 3 depicts a budget approval graphical user interface (GUI), in accordance with some embodiments.

FIG. 4 depicts a budget approval GUI, in accordance with some embodiments.

FIG. 5 depicts a budget approval GUI, in accordance with some embodiments.

FIG. 6 depicts a budget approval GUI, in accordance with some embodiments.

FIG. 7 depicts a budget approval GUI, in accordance with some embodiments.

FIG. 8 depicts a budget approval GUI, in accordance with some embodiments.

FIG. 9 depicts a budget approval GUI, in accordance with some embodiments.

FIG. 10 depicts a budget approval GUI, in accordance with some embodiments.

### DETAILED DESCRIPTION

The following disclosure provides different embodiments, or examples, for implementing features of the provided subject matter. Examples of components, materials, values, steps, arrangements, or the like, are described below to simplify the present disclosure. These are, of course, examples and are not limiting. Other components, materials, values, steps, arrangements, or the like, are contemplated. For example, the formation of a first feature over or on a second feature in the description that follows includes embodiments in which the first and second features are formed in direct contact and includes embodiments in which additional features are formed between the first and second features, such that the first and second features are unable to be in direct contact. In addition, the present disclosure repeats reference numerals and/or letters in the various examples. This repetition is for the purpose of simplicity and clarity and does not dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In some embodiments, a centralized budget approval system (CBAS) is disclosed. In some embodiments, the CBAS allows multiple PICs to review and approve or reject a budget (which include similar or varying costs).

In some embodiments, the CBAS provides a user interface (UI) which allows multiple PICs to access, review, approve, or reject multiple budgets (e.g., department budget, project budget, and other suitable budgets within the contemplated scope of the disclosure) in a systematic and uniform manner. In some embodiments, a PIC inserts comments to specify one or more reasons why the budget was approved or rejected. In some embodiments, an approved budget application, along with reviewer's comments, is automatically forwarded to the next reviewer (e.g., a reviewer in a higher tier of the chain of command or budget approval process). In some embodiments, a rejected budget application, along with the reviewer's comments, is automatically returned to the departmental PIC for correction. For purposes of the present discussion, departmental refers to a budget within a department. Additionally, department refers to a budget for an entire department encompassing one or more departmental budgets.

Generally, a company includes multiple departments, each of which includes multiple teams working on multiple different projects. A portion of the PIC simultaneously manage multiple budgets for multiple parties, including project-team leaders or departmental PICs. In a non-limiting example, a financial PIC reviews and manages multiple budgets for multiple departments, a department-head PIC manages multiple budgets for multiple project teams, and other suitable managers managing other budgets are within the contemplated scope of the disclosure.

Conventionally, a PIC (e.g., a dedicated person from the department such as a department head) applies and obtains a budget amount for the department. When a project team in the department applies for a project budget, a project-team PIC (e.g., a dedicated person from the project team such as a project manager) sends a request, along with details of the project, to the PIC, and the PIC reviews the details to determine whether the applied budget is approved or rejected. In response to the budget application being in good order, then the PIC approves the project-budget application and forwards the project-budget application to the financial department and/or upper management (e.g., head of business unit, board of director, or other suitable manager within the contemplated scope of the disclosure) for further approval, and then informs the team PIC of the approval.

Nevertheless, such conventional approaches and processes are burdensome for the PIC, particularly when the PIC reviews, approves, or rejects budget applications for multiple project teams. Further, each of the multiple project teams provide information in varying styles and varying formats. This results in reviewing difficulties, such as revising each application into a unified style and format before forwarding the budget application to a financial department and/or upper management for further approval. In response to the budget information provided by the project-team PIC or departmental PIC being insufficient or incorrect, the PIC requests further information from the project-team PIC, which results in multiple communications and causes delays in the budget application and approval process.

Further, in response to the budget application including flaws, the reviewer rejects the project-budget application, returns the project-budget application to the PIC, and explains the one or more reasons why the budget application is rejected (e.g., face-to-face explanation, explanation via email, explanation via phone call, or other suitable communications within the contemplated scope of the disclosure). However, this process is burdensome to all reviewers who practice the same procedure. Especially for reviewers who are busy (e.g., executive level reviewer, board of director reviewer, or other suitable high-level manager within the contemplated scope of the disclosure) and in-charge of reviewing a significant number of budget applications. Thus, a reviewer often simply approves or rejects the application without specifying one or more reasons of the decision for approval or rejection. Accordingly, this creates difficulties for subordinates to understand the one or more reasons behind such decisions to approve or reject (e.g., a PIC is unable to understand why a budget application is rejected, a reviewer is unable to understand why the previous reviewer approved the budget application, and other suitable scenarios are within the contemplated scope of the disclosure)

In some embodiments, a CBAS collectively gathers budget applications associated with a PIC and allows the PIC to review, approve, or reject multiple budget applications. In some embodiments, the CBAS is configured to allow the PIC to insert one or more reasons for approval or rejection of the budget, such that the next-tier PIC understands the budget better. In some embodiments, the CBAS is configured to be used by multiple PICs (e.g., PIC, business unit head, board of director, or other suitable manager within the contemplated scope of the disclosure) in approving or rejecting one or more budget applications.

In some embodiments, a budget application contains information regarding budget approval (e.g., approved by a PIC, a final approval from a member from the board of directors, and other suitable next-tier reviewers are within the contemplated scope of the disclosure), and the CBAS processes the budget application and determines a next-tier PIC reviewer. In some embodiments, the CBAS forwards an approved budget application to a first reviewer for review and approval.

In some embodiments, the first PIC reviewer receives a notification (e.g., email, short message service (sms), push notification, or other suitable communications within the contemplated scope of the disclosure) and views the details of the budget application through a graphical user interface (GUI) provided by CBAS. In some embodiments, through the GUI, the first reviewer approves or rejects the budget application, and inserts comments regarding the decision. In response to the first reviewer approving the budget application, the budget application is forwarded to the second (or next tier) reviewer. In some embodiments, the second reviewer sees the comments from the first reviewer (e.g., an urgent status on the budget or other suitable indicator within the contemplated scope of the disclosure). In response to the first reviewer rejecting the budget application, the budget application is returned to the originating PIC (e.g., a departmental PIC). In some embodiments, the originating PIC views the one or more reasons why the budget application is rejected and revise the budget application for re-assessment.

In some embodiments, a CBAS automatically gathers budget applications and forwards the applications to the associated next-tier PICs, simplifying the budget approval process. In some embodiments, the CBAS improves the efficiency of the budget application review and approval processes, which in turn reduces the PICs burden in budget application and management. In some embodiments, the CBAS allows the reviewer to insert comments when deciding (i.e., an approval or rejection), which allows the next reviewer to understand one or more reasons behind a decision and then take appropriate action (e.g., expedite the approval process for urgent/high priority budget, revise the budget application, and other suitable actions within the contemplated scope of the disclosure). In some embodiments, the CBAS is communicatively connected to a master data storage, a created-budget-applications database, terminals for budget PICs, and a terminal for budget reviewers.

In some embodiments, the master data storage includes master data associated with each PIC of the CBAS. In some embodiments, the master data includes information of the PIC, such as the department and team of the PIC, the grade and role of the PIC, the location of the PIC, the project(s) which the PIC is currently handling and/or has handled in the past, and other suitable information within the contemplated scope of the disclosure.

In some embodiments, a PIC logs in to the CBAS through a terminal (e.g., a computer). In some embodiments, the CBAS retrieves master data of the PIC from the master data storage. In some embodiments, the CBAS receives a PIC's input for creating a budget application. In some embodiments, the CBAS determines, based on the master data, whether a department budget associated with the created budget application is found in the database. In response to no existing department budget, the CBAS sends an error message to the PIC, indicating that the department budget is unable to be found and the PIC is unable to apply a budget within the department.

In some embodiments, in response to a department budget being found, the CBAS retrieves the information of the department budget. In some embodiments, the CBAS retrieves the information of each created budget application which is associated with the department budget. In some embodiments, the CBAS produces a total of the retrieved budget application's value and compares the total of the newly created budget application by the PIC.

In some embodiments, in response to the departmental (or project-team) budget application totals being greater than the department budget, the CBAS determines that the newly created departmental budget application (e.g., project budget application) exceeds the department budget. In some embodiments, the CBAS sends an error message to the PIC to explain the overage.

In some embodiments, in response to the departmental (or project-team) budget application total being lower than the department budget, the CBAS determines that the newly created departmental budget application (e.g., project budget application) is within the department budget. In this scenario, the CBAS proceeds to determine, based on the master data of the PIC, a list of reviewers associated with the newly created budget application.

In some embodiments, the CBAS sends the newly created budget application to the first reviewer. In some embodiments, the first reviewer receives a notification regarding the new budget application.

In some embodiments, the first reviewer logs in to the CBAS through a terminal. In some embodiments, the CBAS presents a GUI containing a list of budget applications associated with the first reviewer. In some embodiments, the new departmental budget application is presented at the top of the list, in bold, highlighted, and other suitable indicators are within the contemplated scope of the disclosure, to allow the first reviewer to easily identify the new departmental budget application.

In some embodiments, the GUI includes multiple functional elements (e.g., button, scroll-bar, or other suitable human interface devices within the contemplated scope of the disclosure) which allow the first reviewer to: (a) view the budget applications according to the category of budget applications (e.g., department budget, project budget, or other suitable budget within the contemplated scope of the disclosure), according to the status of the budget applications (e.g., pending, urgent, approved, rejected, or other suitable statuses within the contemplated scope of the disclosure), and according to other information such as financial year, budget type, business unit, department name, total amount, PIC, and other suitable information within the contemplated scope of the disclosure; and (b) view the details of each budget application.

In some embodiments, the CBAS receives an input from the reviewer to select a pending budget application. In some embodiments, the CBAS updates a GUI to display the information of the selected budget application, where the updated GUI includes two functional elements (e.g., buttons or other suitable human interface devices within the contemplated scope of the disclosure) which allow the reviewer to approve/reject the budget application.

In some embodiments, in response to a received input from the reviewer to select one of the functional elements in the CBAS, a pop-out window generates containing a decision button (e.g., a decision button) in an input column, which allows the reviewer to insert comments in response to the one or more reasons for approving or rejecting the budget application. In some embodiments, the decision button is initially locked by the CBAS, such that the reviewer is unable to approve or reject the budget application without a response to the one or more reasons of the decision.

In some embodiments, the reviewer inserts comments into the input column. In some embodiments, the CBAS determines that the number of words inserted into the input column does not exceed a threshold value (e.g., one word [to prevent one word responses, such as approved or denied], 10 words [to encourage detailed elaboration of why a budget is approved or rejected], other suitable limitations within the contemplated scope of the disclosure) and then unlocks the decision button to allow the reviewer to approve/reject the budget application.

In some embodiments, in response to an input to select the decision button, the CBAS updates the status of the budget application for the PIC (e.g., pending, approved by first reviewer, pending approval of second reviewer, budget application approved, or other suitable status identifier within the contemplated scope of the disclosure) and for the first reviewer (e.g., pending approved).

In some embodiments, the CBAS forwards the budget application along with the comments of the first reviewer to the next-tier reviewer (e.g., in response to the first reviewer approving the budget application when there is more than one reviewer for the budget application). In some embodiments, the CBAS returns the budget application to the PIC (e.g., in response to the first reviewer rejecting the budget application).

In some embodiments, in response to the approval of the first reviewer being the final reviewer, then the approval process ends. In some embodiments, the information of the created budget application is stored in the master database.

In some embodiments, the PIC approves or rejects the budget application by a single-click on respective functional elements and insertion of comments for one or more reasons of the decision is optional. In some embodiments, a GUI includes a dedicated functional element (e.g., a dedicated button) to trigger the input column for inputting the comments.

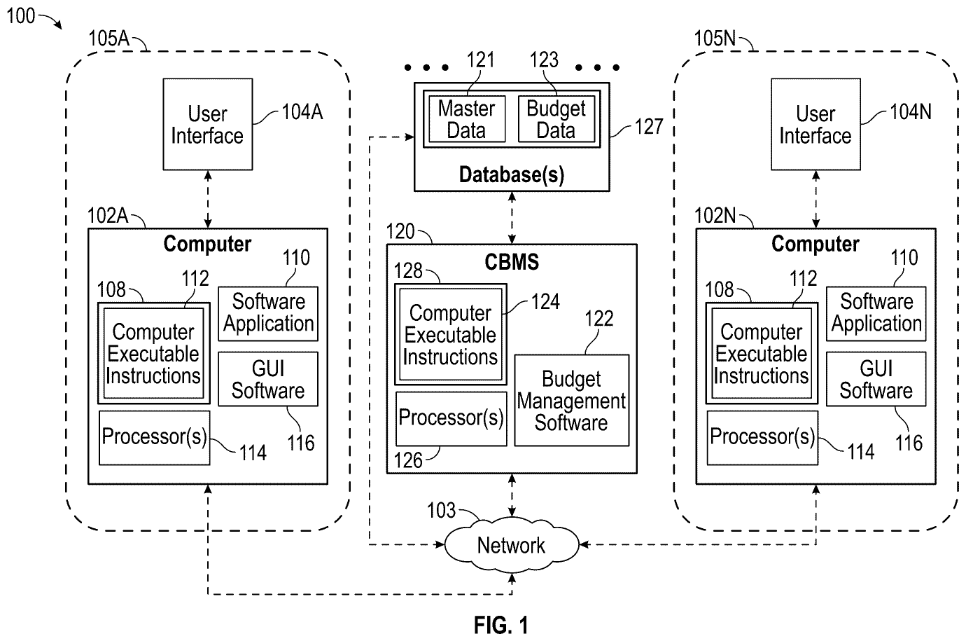

FIG. 1 is a block diagram of a centralized budget approval system (CBAS) 100, in accordance with some embodiments.

CBAS 100 includes computers 102A through 102N (where N is a positive non-zero number and computers 102A through 102N are referred to generically or collectively as computers 102) that are operably connected to user interfaces (UIs) 104A through 104N ((where N is a positive non-zero number and UIs 104A through 104N are referred to generically or collectively as UI 104). Computers 102 are connected to a CBMS 120 through a network 103 and are configured to manage the creation and editing of master data 121, for each CBAS PIC, and budget data 123 through UI 104, and to communicate with CBMS 120 configured to store and retrieve master data 121 and budget data 123 in database 127. In some embodiments, database 127 comprises multiple databases, and each of the master data 121 and budget data 123 is stored in a different database.

Computers 102 are digital electronic machines that are programmed to carry out sequences of arithmetic or logical operations (computation) automatically. Computers 102 perform generic sets of operations known as programs that enable computers 102 to perform a wide range of tasks. In some embodiments, computers 102 are computer systems that include the hardware, operating system (main software), and peripheral equipment. In some embodiments, computers 102 further refer to a group of computers that are linked and function together, such as a computer network or computer cluster.

Computer 102A is included within region 105A and computer 102N is included within region 105N. In some embodiments, regions 105A and 105N are in separate buildings. In some embodiments, regions 105A and 105N are in separate cities. In some embodiments, regions 105A and 105N are in separate states. In some embodiments, regions 105A and 105N are in separate countries. In some embodiments, regions 105A and 105N are in separate divisions within the same company. In some embodiments, regions 105A and 105N are in separate subsidiaries of the same company. In some embodiments, regions 105A and 105N are in separate companies of the same conglomerate.

Computers 102 and CBMS 120 are communicatively connected to network 103 (e.g., through one or more wireless network interfaces such as BLUETOOTH, WIN RESPONSE TOI, WIMAX, GPRS, or WCDMA, one or more wired network interfaces such as ETHERNET, USB, or IEEE-884, or a combination thereof).

Computers 102 are communicatively connected (e.g., through a device interface) to respective UI 104. In some embodiments, several computers are present in CBAS 100. A UI is one or more input/output (I/O) devices capable of displaying information communicated from processing circuitry to one or more PICS (e.g., through a GUI, and other suitable display methodologies within the contemplated scope of the disclosure) receiving input (e.g., by using a keyboard, a mouse, and/or other suitable means for receiving input in conjunction with a GUI, and other suitable peripheral device configured to put information into and get information out of a computer within the contemplated scope of the disclosure) and communicating the input to the processing circuitry (e.g., over one or more networks, and other suitable modes used to exchange messages between terminals within the contemplated scope of the disclosure). In various embodiments, UI 104 includes one or more I/O devices located at a single site or distributed over multiple sites (e.g., throughout a global organization, or different locations within a same region, and other suitable structures within the contemplated scope of the disclosure). In some embodiments, the UI is operably responsive to GUI software 116 discussed below.

In some embodiments, network 103 includes a wide area network (WAN) (i.e., the internet), a wireless WAN (WWAN) (i.e., a cellular network), a local area network (LAN), a wireless LAN (WLAN), a telecommunication network (e.g., 3G, 4G, LTE, 5G, and other suitable communication platforms are within the contemplated scope of the disclosure), or a combination thereof.

Computer executable instructions 112 are stored on non-transitory computer-readable medium 108 within each of computers 102. In some embodiments, a non-transitory computer readable storage medium (e.g., non-transitory computer-readable medium 108) is an electronic, magnetic, optical, electromagnetic, infrared, and/or a semiconductor read circuit (or apparatus or device). For example, a non-transitory computer readable storage medium includes a semiconductor or solid-state memory, a magnetic tape, a removable computer diskette, a random-access memory (RAM), a read-only memory (ROM), a rigid magnetic disk, and/or an optical disk. In some embodiments using optical disks, a non-transitory computer readable storage medium includes a compact disk-read only memory (CD-ROM), a compact disk-read/write (CD-R/W), and/or a digital video disc (DVD).

In some embodiments, forms of non-transitory computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term memory is used herein to refer to a non-transitory computer-readable medium.

Processing circuitry (e.g., one or more processors 114) include a central processing unit (CPU), a multi-processor, a distributed processing read circuit, an application specific integrated circuit (ASIC), a suitable processing unit, a field programmable gate array (FPGA), or a combination thereof. In some embodiments, the processing circuitry corresponds to one or more processors distributed within a cloud computing environment (e.g., over one or more server clusters).

In some embodiments, GUI software 116 supports a form of UI that allows PICs to interact with electronic devices through graphical icons and audio indicator such as primary notation, instead of text-based user interfaces, typed command labels or text navigation. The actions in a GUI are usually performed through direct manipulation of a graphical elements.

In FIG. 1, CBAS 100 includes one or more computers 102 and CBMS 120. In some embodiments, CBAS 100 includes up to N computers 102, and more than one CBMS 120. In a non-limiting example, a CBMS is available for each region or a CBMS is available for a set of regions. In some embodiments, CBMS 120 is containerized and distributed in a cluster of servers. These and other configurations for CBAS 100 are within the scope of this disclosure.

CBMS 120 is one or more computer devices that implements budget management software 122 as computer executable instructions 124 executed on processing circuitry 126, further referred to as processor(s) 126. Computer executable instructions 124 are stored on a non-transitory computer readable medium 128.

Budget management software 122 is configured to manage the creation of a budget application, the submission of the budget application, the approval process of the budget application, the rejection process of the budget application, the routing process of the budget application, and the storing of budget data 123 (e.g., data of the budget application) in database(s) 127 in accordance with method 200 discussed below.

To manage the creation, editing, and storing of budget data 123 in database(s) 127 and to perform other functions, computers 102 implement various software applications 110 and GUI software 116. Software applications 110 and GUI software 116 are provided as computer executable instructions 112 that are executable by processing circuitry 114 in each of computers 102. In some embodiments, software applications 110 are application programming interfaces (APIs) that are a connection between computers, such as CBMS 120, or between computer programs, such as budget management software 122.

Budget data 123 (e.g., department budget data or project budget data discussed below) are database elements including globally applicable, top-level budget data and itemized budget data corresponding to items within a given budget. Non-limiting examples of top-level budget data include department or project names or other identifiers, department or project descriptions, budget types or categories, fiscal years, PIC or other usernames, revision indicators, approval status indicators, total amounts, currency identifiers, cost center or other organizational section identifiers, account level identifiers, and other suitable information within the contemplated scope of the disclosure. Non-limiting examples of itemized budget data include time divisions such as months or quarters, location identifiers, measurement identifiers, item identifiers, item descriptions, unit prices, quantities, rental costs, rental durations, labor rates, labor hours, labor descriptions, outsourcing/contract costs, outsourcing/labor descriptions, team or group identifiers, account level indicators, item amounts, sub-total amounts, currencies, currency exchange rates, and other suitable budget information within the contemplated scope of the disclosure.

The database elements of budget data 123 are controlled by budget management software 122 through processing circuitry 126 as discussed below to have predetermined structures (e.g., data element size, range of values, and other suitable presentations within the contemplated scope of the disclosure) and relationships (e.g., hierarchies, validation links, and other suitable structures within the contemplated scope of the disclosure) whereby budgets created and maintained using CBAS 100 have standardized formatting and operational workflow.

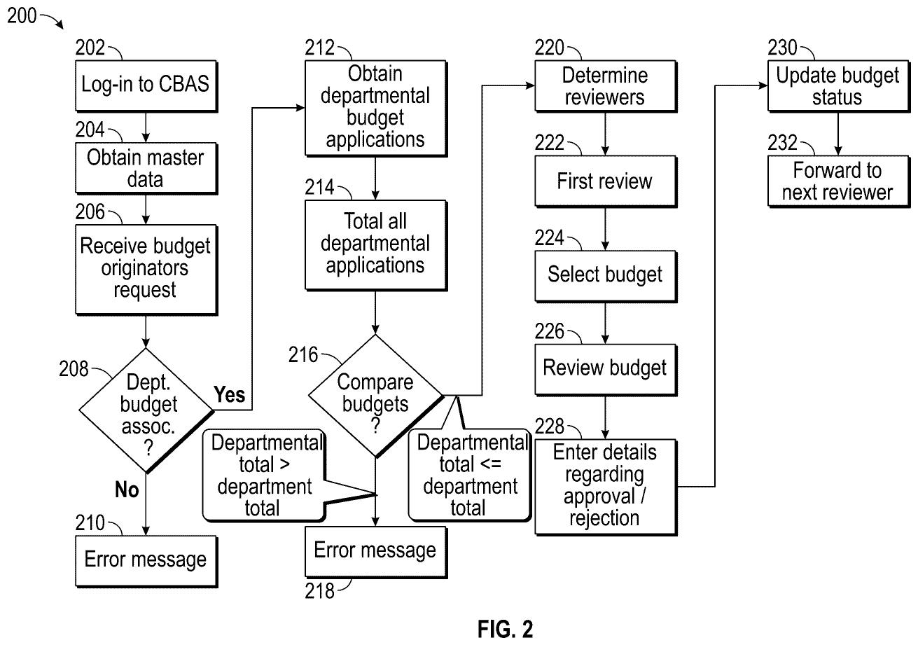

FIG. 2 is a flowchart of a method for budget approval 200, in accordance with some embodiments.

Method 200 is executed by processing circuitry 126 discussed above with respect to FIG. 1. In some embodiments, method 200 is executed by processors 114 through an application programming interface (API) which is a connection between budget management software 122. In some embodiments, method 200 is a method of approving and/or rejecting a budget application from a UI, an uploaded form, an uploaded template, or other suitable user experience (UX) within the contemplated scope of the disclosure. In some embodiments, some, or all the operations of method 200 are executed in accordance with instructions corresponding to budget management software 122 discussed above with respect to FIG. 1.

Method 200 includes operations 202-232, but the operations are not necessarily performed in the order shown. Operations are added, replaced, order changed, and/or eliminated as appropriate, in accordance with the spirit and scope of disclosed embodiments. In some embodiments, one or more of the operations of method 200 are repeated. In some embodiments, unless specifically stated otherwise, the operations of method 200 are performed in order.

Method 200 is discussed with reference to FIGS. 2 and 3-10 that display multiple GUIs in accordance with some embodiments. The discussion of these GUI embodiments are not exhaustive as other suitable GUIs are within the contemplated scope of the disclosure. Further, the structure of each GUI is generic and one of ordinary skill in the art contemplates other variations. Not all GUIs are necessary to the operation of CBAS 100 unless specifically stated otherwise. Further, portions of some GUI embodiments are not shown for the sake of brevity and conciseness. However, one of ordinary skill in the art contemplates other GUIs that are to be added to a systematic and uniform CBAS, such as CBAS 100.

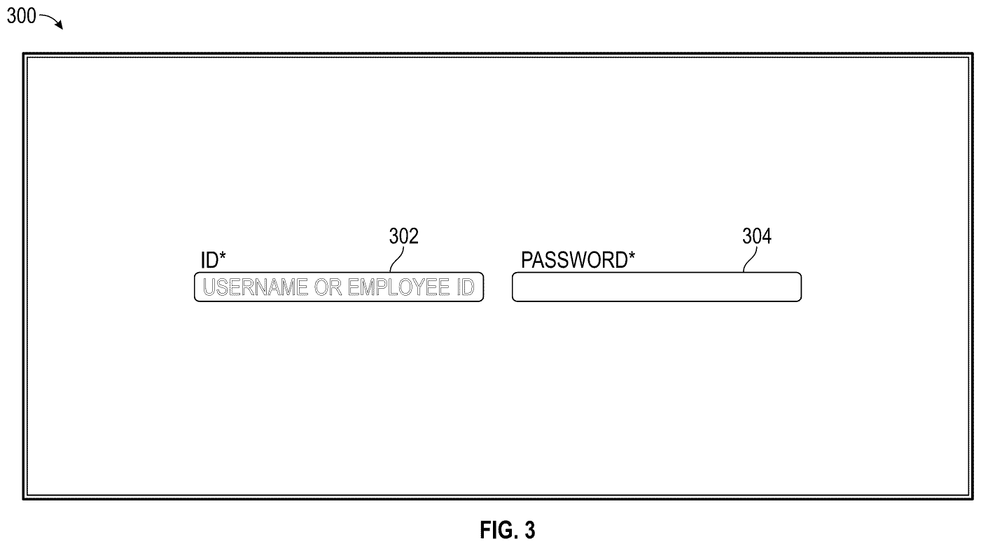

FIG. 3 depicts a budget approval graphical user interface (GUI) 300, in accordance with some embodiments.

In operation 202 of method 200, a project-team manager, a PIC, and/or a reviewer logs-in to CBAS 100 through a UI 104. In a non-limiting example, at GUI 300 a PIC is presented with user input fields 302 and 304. The PIC inputs an ID (such as a username, employee ID, or other suitable identification within the contemplated scope of the disclosure) into PIC input field 302. The identity of the PIC is then confirmed by inputting a password linked to the PIC in PIC input field 304.

In FIG. 1, CBAS 100 is in electronic communication with master data storage 121 that includes master data associated with each PIC (e.g., project-term manager, departmental PIC, PIC, financial PIC, or other suitable budget creator or reviewer within the contemplated scope of the disclosure) of CBAS 100. Master data 121 includes information for each PIC. The master data includes, a region associated with the PIC, PIC department and team of the PIC, the grade and role of the PIC, the location where the PIC works, the project(s) that the PIC is currently handling and/or has handled in the past, and other suitable information within the contemplated scope of the disclosure.

In FIG. 2, operation 204 of method 200, in response to a PIC logging into CBMS 100 (e.g., by inputting identification (ID) at user input field 302 and a password at user input field 304), CBAS 100 extracts the PIC's master data from master data storage 121 and processes the master data to determine a region associated with the PIC, a department (under the region) associated with the PIC, and a team (under the department) associated with the PIC. Process flows from operation 204 to operation 206.

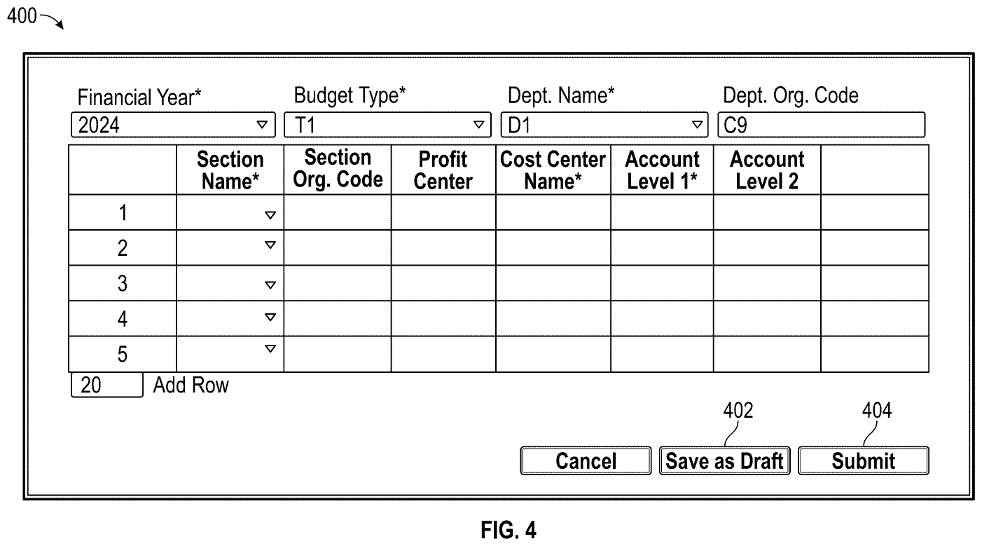

FIG. 4 depicts an approval GUI 400, in accordance with some embodiments.

In operation 206 of method 200, CBAS 100 receives a budget originators request to input or create a departmental budget application. Process flows from operation 206 to operation 208.

In operation 208 of method 200, CBAS 100 determines, based on budget data 123 and/or master data 121, which department budget is associated with the departmental application, and retrieves the department budget (“YES” branch of block 208). In some embodiments, during creation of departmental budget application, in response to CBAS 100 determining that the departmental budget application requested by the budget originators is without an associated department budget, CBAS 100 refuses to allow the originator to create the departmental budget application (“NO” branch of block 208). Thus, a departmental budget application without an associated department budget will not be created.

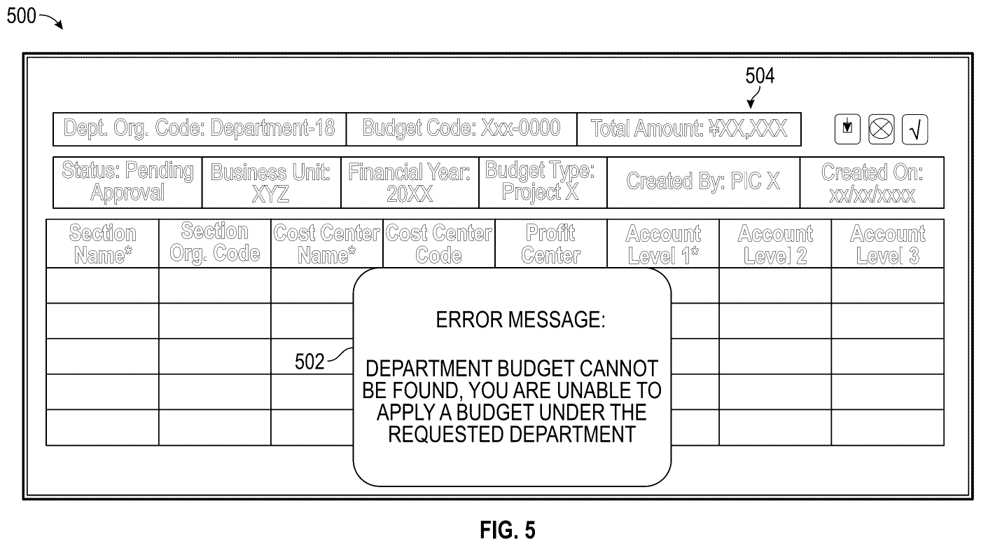

FIG. 5 depicts a budget approval GUI 500, in accordance with some embodiments.

In response to CBAS 100 determining that the departmental budget application requested by the budget originators is without an associated department budget, CBAS 100 refuses to allow the originator to create the budget application (“NO” branch of block 208). CBAS 100 displays error message 502 to the PIC at operation 210, indicating that the department budget is unable to be found and the applicant is unable to apply a budget under the requested department. A department budget is typically created before creating a departmental budget application (e.g., a project budget application) for the department, budget type, and financial year. In some embodiments, in response to a department budget's nonexistence or the amount of the submitted departmental budget exceeds a total amount 504 of the department budget, a departmental PIC receives error message 502, or an error message at operation 218, indicating a departmental budget is being submitted without a department budget or that the total amount of the departmental budget exceeds the department budget. In some embodiments, the reviewer is not able to approve a departmental budget without a department budget. In some embodiments, the reviewer rejects the departmental budget until a department budget is created.

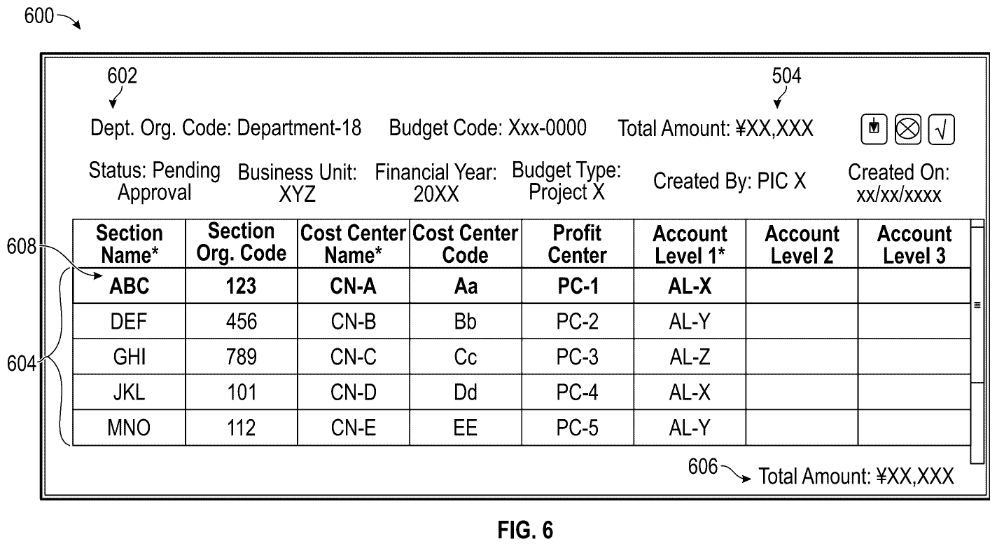

FIG. 6 depicts a budget approval GUI 600, in accordance with some embodiments.

In response to a department budget existing (“YES” branch of block 208) at operation 212, CBAS 100 retrieves a department budget 602 from database 127. CBAS 100 further retrieves information of each created departmental budget application 604 which is associated with the department budget 602. Process flows from operation 212 to operation 214.

In operation 214, CBAS 100 sums the value of each retrieved departmental budget application 604 with the newly submitted departmental budget 608. Process flows from operation 214 to operation 216.

In operation 216, CBAS 100, compares the total amount 606 of the departmental budget applications 604 with the total amount 504 of the department budget 602. In response to total amount 606 of departmental budgets 604 being greater than total amount 504 of department budget 602, CBAS 100 determines that newly created departmental budget application 608 causes the overall department budget to exceed department budget 602. Accordingly, CBAS will send an error message at operation 218, like error message 502, to the PIC to explain why the newly submitted departmental budget application 608, in combination with the submitted departmental budgets 604, exceeds department budget 602.

In response to total amount 606 of the departmental budget applications (e.g., project budget application) being lower than department budget 602 total amount 504, CBAS 100 determines that the newly submitted departmental budget application 608 is allowable within department budget 602. Process flows from operation 218 to operation 220.

In operation 220 of method 200, CBAS 100 determines, based on master data 121 of the departmental PIC, a list of reviewers associated with newly created departmental budget application 608. Process flows from operation 220 to operation 222.

In operation 222 of method 200, CBAS 100 sends departmental budget application 608 to a first reviewer determined from the list of reviewers. In some embodiments, the first reviewer receives a notification (e.g., email, short message service (sms), push notification, or other suitable communications within the contemplated scope of the disclosure) regarding the new budget application.

With reference again to FIGS. 3 and 6, the first reviewer logs in to CBAS 100 via a terminal with GUI 300 (FIG. 3). CBAS 100 presents GUI 600 (FIG. 6) containing a list of budget applications 604 associated with the first reviewer and new budget application 608 is presented in at the top of the list, in bold, highlighted, and other suitable indicators within the contemplated scope of the disclosure, to allow the first reviewer to easily identify new budget application 608.

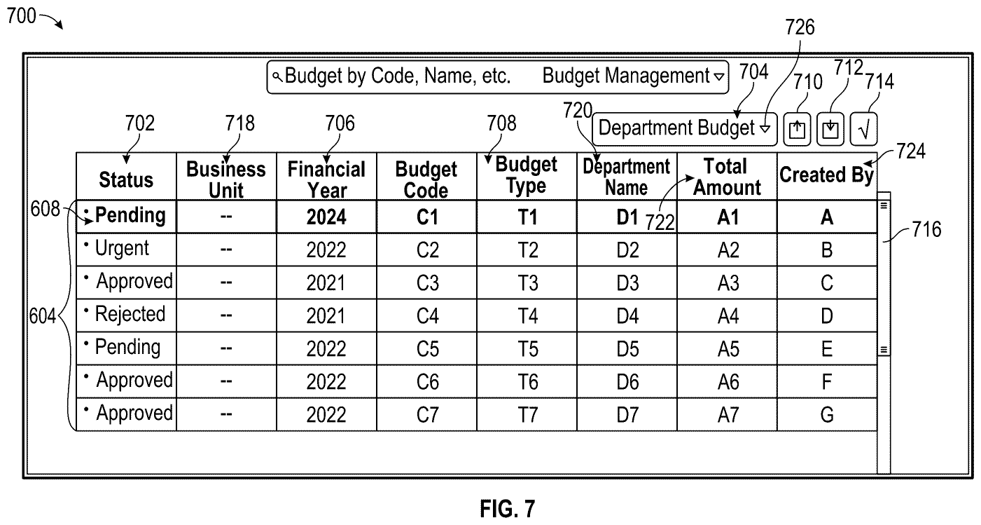

FIG. 7 depicts a budget approval GUI 700, in accordance with some embodiments.

GUI 700 includes multiple functional elements (e.g., user input buttons 710, 712 and 714, scroll-bar 716, and other suitable human interface objects within the contemplated scope of the disclosure) which allows the first reviewer to: (a) view budget applications 604 according to a category of budget applications (e.g., department budget 704, project budget (e.g., a reviewer is able to click on down arrow 726 to select a project budget), and other suitable budgets within the contemplated scope of the disclosure), according to the status 702 of the budget applications (e.g., pending, urgent, approved by . . . , rejected, and other suitable status indicators within the contemplated scope of the disclosure), and according to other information such as financial year 706, budget type 708, business unit 718, department name 720, total amount 722 (e.g., budget which exceeds or is under budget, and other suitable budget indicators within the contemplated scope of the disclosure), applicant 724, and other suitable identifiers within the contemplated scope of the disclosure; (b) view the details of each budget application within budget applications 604. Process flows from operation 222 to operation 224.

In operation 224 of method 200, CBAS 100 receives an input from the reviewer to select a pending budget application. In some embodiments, the reviewer selects a departmental application from list 604. In some embodiments, newly created departmental budget application 608 is highlighted so the reviewer easily identifies the newest unreviewed budget application. Process flows from operation 224 to operation 226.

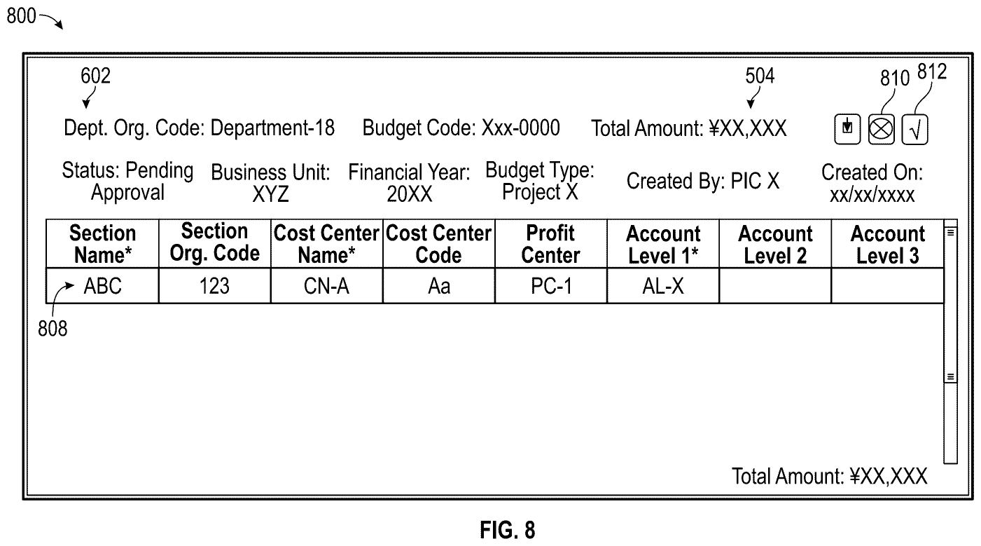

FIG. 8 depicts a budget approval GUI 800, in accordance with some embodiments.

In operation 226 of method 200, CBAS displays or updates a UI 104 to display GUI 800 to show the information of selected budget application 808, where GUI 800 includes functional elements 810 and 812 (e.g., buttons, or other suitable human interface devices within the contemplated scope of the disclosure) which allow the reviewer to approve a budget with functional element 812 or reject a budget application with functional element 810.

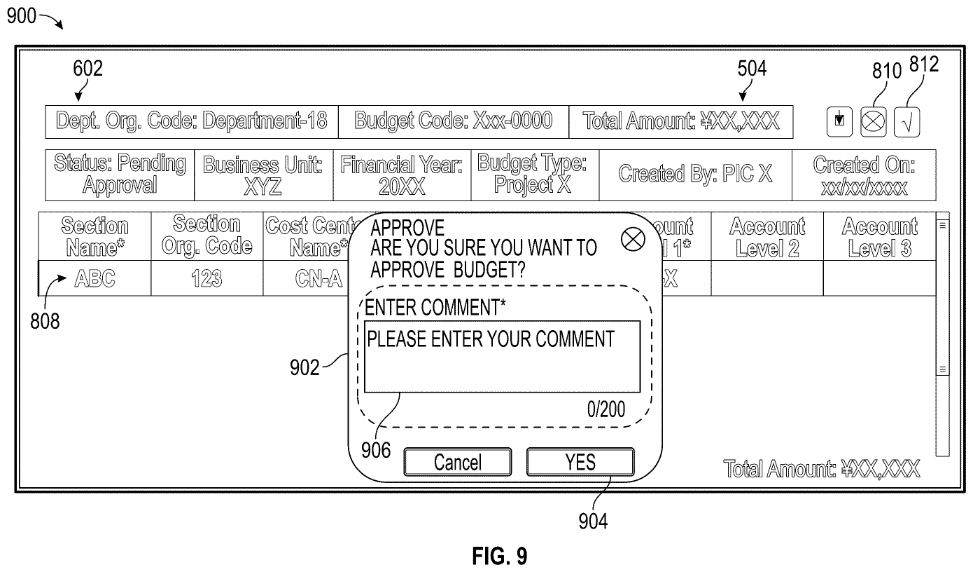

FIG. 9 depicts a budget approval GUI 900, in accordance with some embodiments.

In response to the reviewer approving a budget through clicking on functional element 812, CBAS 100 generates pop-out window 902 which allows the reviewer to insert comments specifying the reason(s) of approving the budget application. The decision button 904 is initially locked by CBAS, such that the reviewer is unable to approve the budget application without specifying the reason(s) of such decision.

In operation 228 of method 200, the reviewer inserts comments into the input column 906. CBAS 100 determines that the number of words inserted into the input column has exceed a threshold value (e.g., one word, 10 words, or the like), and then unlocks the decision button to allow the reviewer to approve the budget application.

In response to CBAS 100 determines the reviewer has inputted a sufficient description for the reason behind the approval of the budget, the reviewer is able to click on decision button 904. Process flows from operation 228 to operation 230.

In operation 230 of method 200, CBAS updates the status of the budget application for the applicant (e.g., from pending to approved by first reviewer, pending approval of second reviewer, or pending to budget application approved, or other suitable status identifiers within the contemplated scope of the disclosure) and for the first reviewer (e.g., pending to approved). Process flows from operation 230 to operation 232.

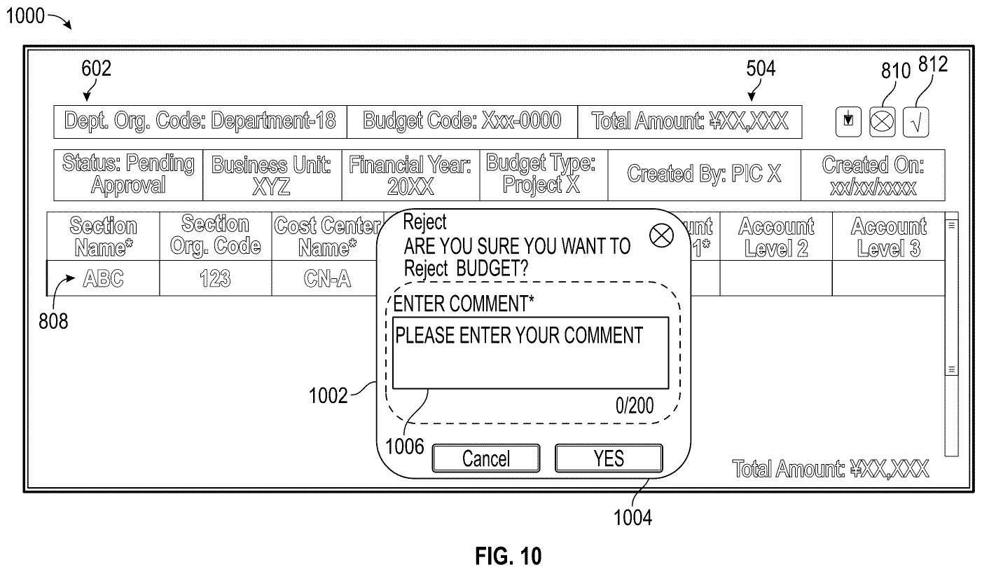

In operation 232, CBAS 100 forwards the approved budget application along with the comments of the first reviewer to the next reviewer (e.g., in response to there being more than one reviewer for the budget application) or returns the budget application to the applicant (e.g., in response to the first reviewer rejecting the budget application FIG. 10). In response to the first reviewer being the final reviewer, then the approval process ends. Subsequently, information of the created budget application will be stored in the database.

FIG. 10 depicts a budget approval GUI 1000, in accordance with some embodiments.

In response to the reviewer rejecting a budget through clicking on functional element 810 (FIG. 8), CBAS 100 generates pop-out window 1002 which allows the reviewer to insert comments specifying the reason(s) of rejecting the budget application. The decision button 1004 is initially locked by CBAS, such that the reviewer is unable to reject the budget application without specifying the reason(s) of such decision.

In operation 228 of method 200, the reviewer inserts comments into the input column 1006. CBAS 100 determines that the number of words inserted into the input column has exceed a threshold value (e.g., one word, 10 words, or the like), and then unlocks decision button 1004 to allow the reviewer to reject the budget application.

In response to CBAS 100 determines the reviewer has inputted a sufficient description for the reason behind the rejection of the budget, the reviewer is able to click on decision button 1004. Process flows from operation 228 to operation 230.

In operation 230 of method 200, CBAS updates the status of the budget application for the applicant (e.g., from pending to rejected by first reviewer, or pending to budget application rejected, or other suitable status identifiers within the contemplated scope of the disclosure) and for the first reviewer (e.g., pending to rejected). Process flows from operation 230 to operation 232.

In operation 232, CBAS 100 returns the budget application to the applicant (e.g., in response to the first reviewer rejecting the budget application FIG. 10). In response to the first reviewer being the final reviewer, then the approval process ends. Subsequently, information of the created budget application will be stored in the database.

In some embodiments, a method executed by processing circuitry includes causing a first graphical user interface (GUI) to be output by a first user interface (UI) includes a first user input field configured to receive a first user input identifying a person-in-charge (PIC) to log in to a centralized budget approval system (CBAS); in response to a successful log into the CBAS, obtaining master data from a non-transitory computer readable medium, the master data being associated with the PIC; determining, based on the master data, a region associated with the PIC; receiving a request from the PIC to create a departmental budget application associated with the determined region; determining a department budget associated with the departmental budget application; and obtaining information of each departmental budget application associated with the department.

In some embodiments, the method further includes determining a combined total value of each departmental budget application with a total value of the department budget application.

In some embodiments, the method further includes comparing the combined total value with a total value of the department budget application.

In some embodiments, the method further includes in response to the combined total value being greater than the total value of the department budget application, updating the first GUI to display an error message field configured to inform the PIC that a requested amount of the departmental budget application resulting in the combined total value of each departmental budget application exceeding the total value of the department budget application.

In some embodiments, the GUI displays an amount of budget available to be applied, to inform the PIC a maximum amount of departmental budget application that is available.

In some embodiments, the method further includes in response to the combined total value being equal to or less than the total value of the department budget application, determining, based on the master data, a list of reviewers of the departmental budget application requested by the PIC.

In some embodiments, the method further includes sending the PIC departmental budget application to a first reviewer in the list of reviewers; and sending a notification to the first reviewer regarding a status of the PIC departmental budget application.

In some embodiments, the method further includes in response to the first reviewer logging into the CBAS, obtaining master data associated with the first reviewer; and causing a second GUI to be output by a second user interface (UI), the second GUI includes a list of departmental budget applications associated with the first reviewer; wherein the PIC departmental budget application is listed first on the list of departmental budget applications and set apart graphically from each departmental budget application; a first user input element to receive a first user element input that is configured to organize the departmental budget applications according to one of: a category of the departmental budget applications; a status of the departmental budget applications; and one or more aspects of the departmental budget applications; and a second user input element to receive a second user element input that is configured to view details of each departmental budget application.

In some embodiments, the method further includes receiving an input from the first reviewer selecting a pending budget application from the list of departmental budget applications; and updating the second GUI to display information related to the selected pending budget application; a third user input element to receive a third user element input that is configured to approve the pending budget application; and a fourth user input element to receive a fourth user element input that is configured to reject the pending budget application.

In some embodiments, the method further includes in response to the third or fourth user input element being selected, updating the second GUI to display a dialog box that is configured to receive input from the first reviewer; and determining the first reviewer inputted a threshold value of characters.

In some embodiments, the method further includes in response to the first reviewer inputted the threshold value of characters, updating a status of the pending budget application; and sending the pending budget application to a second reviewer in the list of reviewers; or in response to the first reviewer being a last reviewer, terminating approval process for the pending budget application.

In some embodiments, a centralized budget approval system (CBAS) includes a memory having non-transitory instructions stored therein; and processing circuitry coupled to the memory, and being configured to execute the instructions, thereby causing the processing circuitry to cause a graphical user interface (GUI) to be output by a user interface (UI), the GUI includes a first user input field configured to receive a first user input identifying a first reviewer to log in to the CBAS; in response to the first reviewer logging into the CBAS, obtain master data associated with the first reviewer; and update the GUI to display a list of departmental budget applications associated with the first reviewer; wherein a most recent departmental budget application is listed first on the list of departmental budget applications and set apart graphically from each departmental budget application; a first user input element to receive a first user element input that is configured to organize the departmental budget applications according to one of a category of the departmental budget applications; a status of the departmental budget applications; and one or more aspects of the departmental budget applications; and a second user input element to receive a second user element input that is configured to view details of each departmental budget application.

In some embodiments, the instructions further cause the processing circuitry to receive an input from the first reviewer selecting a pending budget application from the list of departmental budget applications; and update the GUI to display information related to the selected pending budget application; a third user input element to receive a third user element input that is configured to approve the pending budget application; and a fourth user input element to receive a fourth user element input that is configured to reject the pending budget application.

In some embodiments, the instructions further cause the processing circuitry to in response to the third or fourth user input element being selected, update the GUI to display a dialog box that is configured to receive input from the first reviewer; and determine the first reviewer inputted a threshold value of characters.

In some embodiments, the instructions further cause the processing circuitry to in response to the first reviewer inputted the threshold value of characters, update a status of the pending budget application; and send the pending budget application to a second reviewer in a list of reviewers; or in response to the first reviewer being a last reviewer, terminate approval process for the pending budget application.

In some embodiments, the instructions further cause the processing circuitry to receive a notification regarding a status of a pending departmental budget application; and receive the pending departmental budget application based on a list of reviewers.

In some embodiments, a non-transitory computer readable medium including instructions executable by processing circuitry to cause the processing circuitry to perform operations including causing a graphical user interface (GUI) to be output by a user interface (UI), the GUI including a first user input field configured to receive a first user input identifying a first reviewer to log in to a centralized budget approval system (CBAS); in response to the first reviewer logging into the CBAS, obtaining master data associated with the first reviewer; and updating the GUI to display a list of departmental budget applications associated with the first reviewer; wherein a most recent departmental budget application is listed first on the list of departmental budget applications and set apart graphically from each departmental budget application; a first user input element to receive a first user element input that is configured to organize the departmental budget applications according to one of: a category of the departmental budget applications; a status of the departmental budget applications; and one or more aspects of the departmental budget applications; and a second user input element to receive a second user element input that is configured to view details of each departmental budget application.

In some embodiments, the instructions cause the processing circuitry to further perform operations including receiving an input from the first reviewer selecting a pending budget application from the list of departmental budget applications; and updating the GUI to display information related to the selected pending budget application; a third user input element to receive a third user element input that is configured to approve the pending budget application; and a fourth user input element to receive a fourth user element input that is configured to reject the pending budget application.

In some embodiments, the instructions cause the processing circuitry to further perform operations including in response to the third or fourth user input element being selected, updating the GUI to display a dialog box that is configured to receive input from the first reviewer; and determining the first reviewer inputted a threshold value of characters.

In some embodiments, the instructions cause the processing circuitry to further perform operations including in response to the first reviewer inputted the threshold value of characters, updating a status of the pending budget application; and sending the pending budget application to a second reviewer in a list of reviewers; or in response to the first reviewer being a last reviewer, terminating approval process for the pending budget application.

In some embodiments, the instructions cause the processing circuitry to further perform operations including receiving a notification regarding a status of a pending departmental budget application; and receiving the pending departmental budget application based on a list of reviewers.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should further realize that such equivalent constructions do not depart from the spirit and scope of the present disclosure, and that they may make various changes, substitutions, and alterations herein without departing from the spirit and scope of the present disclosure.

What is claimed is:

1. A method executed by processing circuitry, the method comprising:
causing a first graphical user interface (GUI) to be output by a first user interface (UI), the first GUI comprising:
a first user input field configured to receive a first user input identifying a person-in-charge (PIC) to log in to a centralized budget approval system (CBAS);
in response to a successful log into the CBAS, obtaining master data from a non-transitory computer readable medium, the master data being associated with the PIC;
determining, based on the master data, a region associated with the PIC;
receiving a request from the PIC to create a departmental budget application associated with the determined region;
determining, based on the master data, whether a department budget associated with the departmental budget application is applied towards the department budget, has been previously created;
in response to the department budget being included in the master data, updating the first GUI to display an error message field configured to inform the PIC the departmental budget application is unable to be created; and
obtaining information of each departmental budget application associated with the department.

2. The method of claim 1, further comprising:
determining a combined total value of each departmental budget application and the departmental budget application requested by the PIC.

3. The method of claim 2, further comprising:
comparing the combined total value with a total value of the department budget application.

4. The method of claim 3, further comprising:
in response to the combined total value being greater than the total value of the department budget application, updating the first GUI to display an error message field configured to inform the PIC that a total value of the departmental budget application results in the combined total value of each departmental budget application exceeding the total value of the department budget application.

5. The method of claim 3, further comprising:
in response to the combined total value of each department budget application being equal to or less than the total value of the department budget application, determining, based on the master data, a list of reviewers of the PIC departmental budget application.

6. The method of claim 5, further comprising:
sending the PIC departmental budget application to a first reviewer in the list of reviewers; and
sending a notification to the first reviewer regarding a status of the PIC departmental budget application.

7. The method of claim 6, further comprising:
in response to the first reviewer logging into the CBAS, obtaining master data associated with the first reviewer; and
causing a second GUI to be output by a second user interface (UI), the second GUI comprising:
a list of departmental budget applications associated with the first reviewer; wherein the PIC departmental budget application is listed first on the list of departmental budget applications and set apart graphically from each departmental budget application;
a first user input element to receive a first user element input that is configured to organize the departmental budget applications according to one of:
a category of the departmental budget applications;
a status of the departmental budget applications; and
one or more aspects of the departmental budget applications; and
a second user input element to receive a second user element input that is configured to view details of each departmental budget application.

8. The method of claim 7, further comprising:
receiving an input from the first reviewer selecting a pending budget application from the list of departmental budget applications; and
updating the second GUI to display:
information related to the selected pending budget application;
a third user input element to receive a third user element input that is configured to approve the pending budget application; and
a fourth user input element to receive a fourth user element input that is configured to reject the pending budget application.

9. The method of claim 8, further comprising:
in response to the third or fourth user input element being selected, updating the second GUI to display a dialog box that is configured to receive input from the first reviewer; and
determining the first reviewer inputted a threshold value of characters.

10. The method of claim 9, further comprising:
in response to the first reviewer inputted the threshold value of characters, updating a status of the pending budget application; and
sending the pending budget application to a second reviewer in the list of reviewers; or
in response to the first reviewer being a last reviewer, terminating approval process for the pending budget application.

11. A centralized budget approval system (CBAS), comprising:
a memory having non-transitory instructions stored therein; and
processing circuitry coupled to the memory, and being configured to execute the instructions, thereby causing the processing circuitry to:
cause a graphical user interface (GUI) to be output by a user interface (UI), the GUI comprising:
a first user input field configured to receive a first user input identifying a first reviewer to log in to the CBAS;
in response to the first reviewer logging into the CBAS, obtain master data associated with the first reviewer; and
update the GUI to display:
a list of departmental budget applications associated with the first reviewer; wherein a most recent departmental budget application is listed first on the list of departmental budget applications and set apart graphically from each departmental budget application;
a first user input element to receive a first user element input that is configured to organize the departmental budget applications according to one of:
a category of the departmental budget applications;
a status of the departmental budget applications; and
one or more aspects of the departmental budget applications; and
a second user input element to receive a second user element input that is configured to view details of each departmental budget application.

12. The CBAS of claim 11, wherein the instructions further cause the processing circuitry to:
receive an input from the first reviewer selecting a pending budget application from the list of departmental budget applications; and
update the GUI to display:
information related to the selected pending budget application;
a third user input element to receive a third user element input that is configured to approve the pending budget application; and
a fourth user input element to receive a fourth user element input that is configured to reject the pending budget application.

13. The CBAS of claim 12, wherein the instructions further cause the processing circuitry to:
in response to the third or fourth user input element being selected, update the GUI to display a dialog box that is configured to receive input from the first reviewer; and
determine the first reviewer inputted a threshold value of characters.

14. The CBAS of claim 13, wherein the instructions further cause the processing circuitry to:
in response to the first reviewer inputted the threshold value of characters, update a status of the pending budget application; and
send the pending budget application to a second reviewer in a list of reviewers; or
in response to the first reviewer being a last reviewer, terminate approval process for the pending budget application.

15. The CBAS of claim 11, wherein the instructions further cause the processing circuitry to:
receive a notification regarding a status of a pending departmental budget application; and
receive the pending departmental budget application based on a list of reviewers.

16. A non-transitory computer readable medium including instructions executable by processing circuitry to cause the processing circuitry to perform operations comprising:
causing a graphical user interface (GUI) to be output by a user interface (UI), the GUI comprising:
a first user input field configured to receive a first user input identifying a first reviewer to log in to a centralized budget approval system (CBAS);
in response to the first reviewer logging into the CBAS, obtaining master data associated with the first reviewer; and
updating the GUI to display:
a list of departmental budget applications associated with the first reviewer; wherein a most recent departmental budget application is listed first on the list of departmental budget applications and set apart graphically from each departmental budget application;
a first user input element to receive a first user element input that is configured to organize the departmental budget applications according to one of:
a category of the department budget applications;
a status of the departmental budget applications; and
one or more aspects of the departmental budget applications; and
a second user input element to receive a second user element input that is configured to view details of each departmental budget application.

17. The non-transitory computer readable medium of claim 16, wherein the instructions cause the processing circuitry to further perform operations comprising:
receiving an input from the first reviewer selecting a pending budget application from the list of departmental budget applications; and
updating the GUI to display:
information related to the selected pending budget application;
a third user input element to receive a third user element input that is configured to approve the pending budget application; and
a fourth user input element to receive a fourth user element input that is configured to reject the pending budget application.

18. The non-transitory computer readable medium of claim 17, wherein the instructions cause the processing circuitry to further perform operations comprising:
in response to the third or fourth user input element being selected, updating the GUI to display a dialog box that is configured to receive input from the first reviewer; and
determining the first reviewer inputted a threshold value of characters.

19. The non-transitory computer readable medium of claim 18, wherein the instructions cause the processing circuitry to further perform operations comprising:
in response to the first reviewer inputted the threshold value of characters, updating a status of the pending budget application; and
sending the pending budget application to a second reviewer in a list of reviewers; or
in response to the first reviewer being a last reviewer, terminating approval process for the pending budget application.

20. The non-transitory computer readable medium of claim 16, wherein the instructions cause the processing circuitry to further perform operations comprising:
receiving a notification regarding a status of a pending departmental budget application; and
receiving the pending departmental budget application based on a list of reviewers.
